(19) United States
(12) Patent Application Publication
(10) Pub. No.: US 2022/0153202 A1
(43) Pub. Date: May 19, 2022

(54) MOTOR VEHICLE ASSEMBLY HAVING A CENTER COMPONENT

(71) Applicant: Brose Fahrzeugteile SE & Co. Kommanditgesellschaft, Coburg, Coburg (DE)

(72) Inventors: Hartmut BEYERSDORFER, Coburg (DE); Mario WAZANINI, Steinsdorf (DE); Markus BAUERNFEIND, Coburg (DE); Matthias ZÄNSLER, Halle (DE); Oliver REINECKE, Halle (DE)

(73) Assignee: Brose Fahrzeugteile SE & Co. Kommanditgesellschaft, Coburg, Coburg (DE)

(21) Appl. No.: 17/352,878

(22) PCT Filed: Dec. 17, 2019
(86) PCT No.: PCT/EP2019/085505

§ 371 Date: Aug. 19, 2021

(30) Foreign Application Priority Data
Dec. 21, 2018 (DE) 10 2018 222 852.3

(51) Int. Cl. B60R 7/06

(52) U.S. Cl. CPC B60R 7/06

(57) ABSTRACT

A motor vehicle assembly having a center component which can be arranged between two vehicle seats on a vehicle floor and which can be moved along a first direction parallel to the vehicle floor. The center component can additionally be moved along a second direction perpendicular to the vehicle floor.

### CROSS-REFERENCE TO RELATED APPLICATIONS

This application is the U.S. National Phase of PCT Application No. PCT/EP2019/085505 filed on Dec. 17, 2019, which claims priority to German Patent Application No. DE 10 2018 222 852.3, filed on Dec. 21, 2018, the disclosures of which are hereby incorporated in their entirety by reference herein.

### TECHNICAL FIELD

The present disclosure relates to a motor vehicle assembly having a center component.

### BACKGROUND

Such a motor vehicle assembly can be suitable for arrangement between two vehicle seats on a vehicle floor. For example, the motor vehicle assembly can be suitable for arrangement between a driver seat and a front passenger seat. The motor vehicle assembly is shiftable along a first direction parallel to the vehicle floor. The first direction can be extended for example along a longitudinal vehicle axis, which can form an X-axis of the motor vehicle.

### SUMMARY

One or more objects of the present disclosure may be to improve a motor vehicle assembly with regard to its flexibility and usability.

A proposed motor vehicle assembly provides that the center component is additionally shiftable along a second direction perpendicular to the vehicle floor. The second direction can be formed for example, by a Z-axis of the motor vehicle and/or be arranged perpendicularly to the first direction.

In an exemplary embodiment, the center component is configured as a center console and may include at least one arm support. In principle, the center component can provide a multitude of functions. This includes for example the at least one arm support, at least one storage unit, at least one actuating element and/or at least one touch-sensitive input/output unit.

In an embodiment in which the center component provides at least one arm support, the position of the at least one arm support along the longitudinal vehicle axis can be adaptable to a longitudinal position of an arm of a user of one of the vehicle seats by a displacement along the first direction. By a displacement along the second direction, the position of the at least one arm support transversely to the longitudinal vehicle axis can be adaptable to a height of an arm of a user of one of the vehicle seats. Hence, for example the ergonomics of the motor vehicle assembly can be adaptable to a current position of a driver in an interior space of the motor vehicle. In addition, the motor vehicle assembly and for example, the center component can at least partly be shifted under the dashboard to expand an interior space of the motor vehicle, so that a space between two vehicle seats is cleared by shifting the motor vehicle assembly. The space can at least partly be cleared proceeding from the vehicle floor when the center component is at least partly shifted under the dashboard. The center component hence in principle is stowable in an area of the motor vehicle, such as the area under the dashboard.

In one or more embodiments, the center component can comprise one or more of a storage unit for storing objects, an emergency seat, a table and/or a cooling box. As an example, the center component can be exchangeable with at least one further center component so that a user of the motor vehicle assembly can choose between various configurations of center components for adaptation to his/her needs when utilizing the motor vehicle assembly.

In an exemplary embodiment, the motor vehicle assembly has a modular design. The center component then can be designed to be separable from the motor vehicle assembly so that the center component can be removed from the motor vehicle. For example, storage units that are arranged in the center component, such as storage compartments, can be loaded and/or unloaded outside the motor vehicle.

In an exemplary embodiment, the motor vehicle assembly may include at least one guide arm. The at least one guide arm can be designed as a side bar relative to the center component. For example, the at least one guide arm can be arranged along a vehicle seat. The center component can be arranged on the at least one guide arm. In one configuration, the at least one guide arm supports the center component above the vehicle floor. For this purpose, the at least one guide arm can be arranged on a vehicle body. The vehicle body at least can comprise the vehicle floor and/or the dashboard.

As an example, the at least one guide arm can be shiftably arranged on the vehicle body along the first direction. For this purpose, at least one floor rail can be provided in the vehicle floor, which is extended along the first direction and on which the at least one guide arm is shiftably mounted. Due to the shiftable arrangement of the at least one guide arm on the vehicle body, the center component can also be shiftable along the first direction together with the at least one guide arm.

The at least one guide arm can also be suitable for arrangement on the dashboard of the motor vehicle in addition or as an alternative to an arrangement on the vehicle floor. The at least one guide arm therefor can engage into the dashboard or a front of the motor vehicle, which can face the vehicle seats.

In another, the center component is releasably arranged on the at least one guide arm for exchange with a further center component. The center component hence can be detached from the at least one guide arm, be removed from the motor vehicle, and the further center component can be arranged on the at least one guide arm. The further center component hence can replace the center component. For example, it can be provided to exchange an emergency seat as a center component on the at least one guide arm for a cooling box as a further center component.

In another exemplary embodiment, at least one ventilation duct for the transport of air along the first direction is extended along the at least one guide arm. The at least one ventilation duct can be extended from a front side of the motor vehicle into a rear compartment of the motor vehicle so that air is transmitted from the front side to a passenger on a rear bench.

Between the vehicle seats two guide arms can be arranged, between which the center component is arranged. This can provide for a non-tilting arrangement of the center component. Due to the arrangement on the two guide arms, the center component hence can be held in the plane that is defined by the first and the second direction. As an example, the center component can be releasably connected to the two guide arms. In principle, each of the two guide arms can include a ventilation duct. In one embodiment, one of the two guide arms may include a ventilation duct.

The two guide arms can be arranged symmetrically with respect to a mirror plane between the vehicle seats, such as between the driver seat and the front passenger seat. The mirror plane can be extended along the first direction and the second direction. In one embodiment, the mirror plane centrally intersects the center component. Hence, when one of the two guide arms adjoins the driver seat, the other of the two guide arms can adjoin the front passenger seat. The center component then can be arranged centrally between the guide arm on the side of the driver seat and the guide arm on the side of the front passenger seat.

In another exemplary embodiment, at least one first adjusting mechanism is arranged on the at least one guide arm. An actuation of the at least one first adjusting mechanism can cause an adjustment of the at least one guide arm along the first direction. Hence, the at least one guide arm can be shiftable relative to the vehicle body along the first direction via the at least one first adjusting mechanism. For example, the at least one guide arm can slide over the vehicle floor or be shifted into the dashboard or out of the dashboard via the at least one first adjusting mechanism so that the at least one guide arm at least partly disappears in the dashboard. In principle, more than one first adjusting mechanism can be arranged on the at least one guide arm for shifting the at least one first guide arm along the first direction.

The displacement of the at least one first guide arm along the first direction likewise can effect a displacement of the center component along the first direction together with the at least one first guide arm. The at least one guide arm and the center component hence can be jointly shiftable along the first direction. For example, the at least one guide arm together with the center component can be shiftable into a parking position in the dashboard or can be shiftable under the dashboard.

In another exemplary embodiment, the center component can also be shiftable relative to the at least one guide arm. The center component can be arbitrarily shiftable relative to the at least one guide arm along the mirror plane. In principle, the center component can be shiftable relative to the at least one guide arm along the first direction in order to for example adapt a position of the center component to a longitudinal position of a driver or front passenger along the longitudinal vehicle axis. The center component likewise can be shiftable relative to the at least one guide arm along the second direction in order to for example adapt a height of the center component to a height of the driver or front passenger perpendicularly to the vehicle floor.

The motor vehicle assembly can be shiftable into a parking position under or in the dashboard. For this purpose, the center component can be shifted relative to the at least one guide arm in the direction of the vehicle floor in order to reduce a height of the motor vehicle assembly above the vehicle floor. Furthermore, the center component can be shifted relative to the at least one guide arm along the first direction in the direction of the dashboard in order to reduce a length of the motor vehicle assembly along the longitudinal vehicle axis. In addition, the at least one guide arm can be shifted along the first direction together with the center component. As an example, a free space in an interior space of the motor vehicle can thereby be increased as compared to an arrangement of the motor vehicle assembly outside the parking position. The additional free space can be usable for example for traversing vehicle seats for instance in an autonomous driving mode and/or for arranging other objects in the interior space and for example, on the vehicle floor.

In an exemplary embodiment, at least one second adjusting mechanism is arranged on the at least one guide arm, by which the center component is shiftable along the first direction relative to the at least one first guide arm. Via the at least one second adjusting mechanism, the center component hence can be adjustable along the same adjustment direction along which the motor vehicle assembly can be adjustable by the at least one first adjusting mechanism. Hence, the at least one first and the at least one second adjusting mechanism together can realize a telescopic adjustment of the motor vehicle assembly along the first direction, wherein on the one hand the at least one guide arm and on the other hand the center component can be adjustable relative to the at least one guide arm along the first direction. Via the at least one second adjusting mechanism, the center component may be extendable from the at least one guide arm and can be pushed together with the at least one guide arm.

The motor vehicle assembly for example can comprise a second adjusting mechanism which is arranged on the side of the center component facing the vehicle floor. The second adjusting mechanism then can engage a carrier element which is connected to the at least one guide arm. Via the second adjusting mechanism, the center component hence can be adjustable relative to the carrier element along the first direction.

The motor vehicle assembly likewise may include at least one second adjusting mechanism which is arranged on a side of the center component facing the at least one guide arm so that the at least one second adjusting mechanism engages the at least one guide arm. In one variant, the at least one second adjusting mechanism is arranged on the at least one guide arm so that the at least one second adjusting mechanism engages a side of the center component facing the at least one guide arm.

In another exemplary embodiment, the motor vehicle assembly may include at least one third adjusting mechanism. The at least one third adjusting mechanism can be arranged on the at least one guide arm. In principle, the at least one third adjusting mechanism likewise can be arranged on the center component. For example, the at least one third adjusting mechanism can be arranged on a side of the center component facing the vehicle floor or on a side of the center component facing the at least one guide arm. Via the at least one third adjusting mechanism, the center component can be shiftable relative to the at least one guide arm along the second direction.

For this purpose, the at least one third adjusting mechanism for example can engage the carrier element so that the center component is shiftable relative to the carrier element along the second direction via the at least one third adjusting mechanism. The at least one third adjusting mechanism likewise can engage a side of the center component facing the at least one guide arm.

The weight of the center component in principle can be borne by the at least one third adjusting mechanism on the at least one guide arm. Additionally or alternatively, the weight of the center component can be supported by at least one support element on the at least one guide arm. A height along the second direction, on which the at least one support element supports the center component, can be adaptable together with the at least one third adjusting mechanism. The at least one support element can be designed for example as a gas-pressure spring. The weight of the center component can be supported via an expansion pressure of a gas. The gas can be contained in the gas-pressure spring. The weight of the center component can cause a compression of the gas so that the weight is supported via a back pressure caused by the expansion pressure of the gas. The at least one support element can be arranged on the at least one guide arm and engage the center component so that the weight of the center component is supported on the at least one guide arm via the support element.

In principle, the at least one first, second and third adjusting mechanism can be formed by a spindle drive. The adjusting movement can then be generated via a spindle. The spindle can be used to adjust at least one carriage along a guideway associated with the at least one carriage. The at least one carriage hence can be guided on the associated guideway.

The at least one first adjusting mechanism can be arranged on the at least one guide arm. At least one first carriage of the at least one first adjusting mechanism then can be body-mounted so that the associated first guideway is shifted on the at least one first carriage for an adjustment of the at least one guide arm along the first direction. In an alternative embodiment, the at least one first adjusting mechanism is body-mounted. For example, the at least one first adjusting mechanism can be arranged on the vehicle floor or on the dashboard. The at least one first carriage then can engage the motor vehicle assembly. A displacement of the at least one first carriage along the associated guideway then can effect an adjusting movement of the at least one guide arm.

The at least one second adjusting mechanism can be arranged on the at least one guide arm. At least one second carriage then can engage the center component in order to adjust the center component relative to the at least one guide arm along the first direction. The at least one second carriage can be shiftable along an associated second guideway which is arranged on the at least one guide arm.

In an alternative embodiment, the at least one second adjusting mechanism is arranged on the center component. The at least one second carriage then can engage the at least one guide arm. The second guideway associated with the at least one second carriage then can be shiftable along the at least one second carriage so that via the adjusting movement of the associated second guideway on the at least one second carriage, the center component is adjusted relative to the at least one guide arm along the first direction.

The at least one third adjusting mechanism in principle can be arranged on the at least one guide arm. At least one third carriage then can engage the center component in order to adjust the center component relative to the at least one guide arm along the second direction. The at least one third carriage can be shiftable along an associated third guideway which is arranged on the at least one guide arm.

The at least one second and the at least one third adjusting mechanism can cooperate in order to provide for a displacement of the center component relative to the at least one guide arm along a plane that is defined by the first direction and the second direction. For example, the at least one third adjusting mechanism can be arranged on the at least one second adjusting mechanism so that the at least one third adjusting mechanism is shiftable along the first direction via the at least one second adjusting mechanism. The at least one second adjusting mechanism then can be arranged for example on the at least one guide arm so that the at least one second carriage is guided on the at least one guide arm along an associated second guideway. The at least one second carriage then can engage the at least one third adjusting mechanism, which in turn engages the center component. The at least one second adjusting mechanism hence can engage the at least one third adjusting mechanism in order to provide for a displacement of the center component together with the at least one third adjusting mechanism.

In an alternative embodiment, the at least one second adjusting mechanism can be arranged on the at least one third adjusting mechanism so that the at least one second adjusting mechanism is shiftable along the second direction via the at least one third adjusting mechanism. The at least one third adjusting mechanism then can be arranged for example on the at least one guide arm so that the at least one third carriage is guided on the at least one guide arm along an associated third guideway. The at least one third carriage then can engage the at least one second adjusting mechanism, which in turn engages the center component. The at least one third adjusting mechanism hence can engage the at least one second adjusting mechanism in order to provide for a displacement of the center component together with the at least one second adjusting mechanism.

The at least one third adjusting mechanism can include a carrier element via which the at least one third adjusting mechanism is connected to the center component. The at least one second adjusting mechanism can be arranged on the carrier element so that the displacement of the center component along the first direction is effected relative to the carrier element. The carrier element can be configured as a bridge across the vehicle floor between two guide arms arranged in parallel, each provided with a third adjusting mechanism. In such an embodiment, the carrier element can each be connected to the third carriage of the two third adjusting mechanisms so that both a displacement of the third carriages along the second direction and a displacement of the carrier element along the second direction is affected.

The center component can be arranged on the at least one carriage so that an adjustment of the at least one carriage along the associated guideway each effects an adjustment of the center component along the first or second direction.

In an alternative embodiment, the carrier element is arranged on the at least one guide arm via the at least one second adjusting mechanism. The carrier element hence can be shiftable along the first direction via the at least one second adjusting mechanism. On the carrier element the at least one third adjusting mechanism can be arranged, on which the center component is arranged. The carrier element for example can be extended along a plane along which the first direction is extended. The at least one third adjusting mechanism can effect a displacement of the center component along the second direction relative to the carrier element.

The at least one first, second and/or third adjusting mechanism each can include a spindle drive, a rack-and-pinion drive, a cable drive and/or a lever drive. As an example the at least one third adjusting mechanism, but in principle also the at least one first and second adjusting mechanisms, additionally or alternatively can include a lever kinematics, that may include a spindle, and/or a pinion drive; a linear guideway, that may include a toothed rack and/or a cable drive; a cross lever and/or a Bowden cable.

In an exemplary embodiment, the at least one first, second and/or third carriage each is shiftable along the associated first, second and/or third guideway via a first, second and/or third spindle. The first, second and/or third spindle for example can each be drivable via a first, second and/or third spindle drive, that may include a motor unit and possibly a transmission unit.

### BRIEF DESCRIPTION OF THE DRAWINGS

In the attached Figures, exemplary embodiments of the proposed solution are illustrated by way of example. In the drawing:

FIG. 1 shows a motor vehicle assembly between two vehicle seats;

FIG. 2 shows a motor vehicle assembly comprising a center component and two guide arms between two vehicle seats;

FIG. 3 shows a motor vehicle assembly on a dashboard;

FIG. 4 shows a perspective view of two first and one third adjusting mechanism;

FIG. 5 shows another perspective view of two first and one third adjusting mechanism;

FIG. 6 shows a sectional view through a guide arm comprising a first and a second adjusting mechanism;

FIG. 7 shows a motor vehicle assembly comprising a ventilation duct;

FIG. 8A shows two guide arms comprising a first, a second and two third adjusting mechanisms;

FIG. 8B shows a guide arm comprising a first, second and third adjusting mechanism with a carrier element;

FIG. 9 shows a bottom view of a first adjusting mechanism;

FIG. 10 shows a bottom view of the motor vehicle assembly;

FIG. 11A shows a parking position of a motor vehicle assembly;

FIG. 11B shows a normal position of a motor vehicle assembly;

FIG. 11C shows an extended position of a motor vehicle assembly;

FIG. 11D shows a relax position;

FIG. 12A shows a motor vehicle assembly in a motor vehicle in the parking position;

FIG. 12B shows a motor vehicle assembly in a motor vehicle in the normal position; and

FIG. 12C shows a motor vehicle assembly in a motor vehicle in the extended position.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

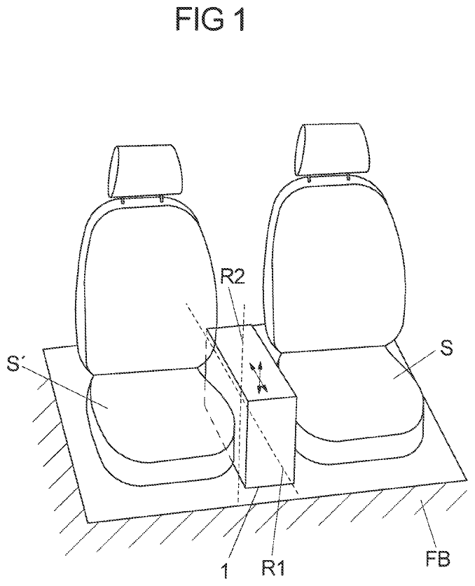

FIG. 1 shows a motor vehicle assembly having a center component 1. The center component 1 is arranged on a vehicle floor FB between a driver seat S and a front passenger seat S′. Moreover, the center component 1 is shiftable along a first direction R1, which is extended parallel to the vehicle floor FB and along a longitudinal vehicle axis L, and additionally is shiftable along a second direction R2 perpendicular to the vehicle floor FB. The center component 1 hence is longitudinally shiftable and shiftable in height relative to an occupant of the motor vehicle properly seated on the vehicle seat S or front passenger seat S′. In principle, the center component 1 can be shiftable to any position along a plane perpendicular to the vehicle floor FB between the motor vehicle seats.

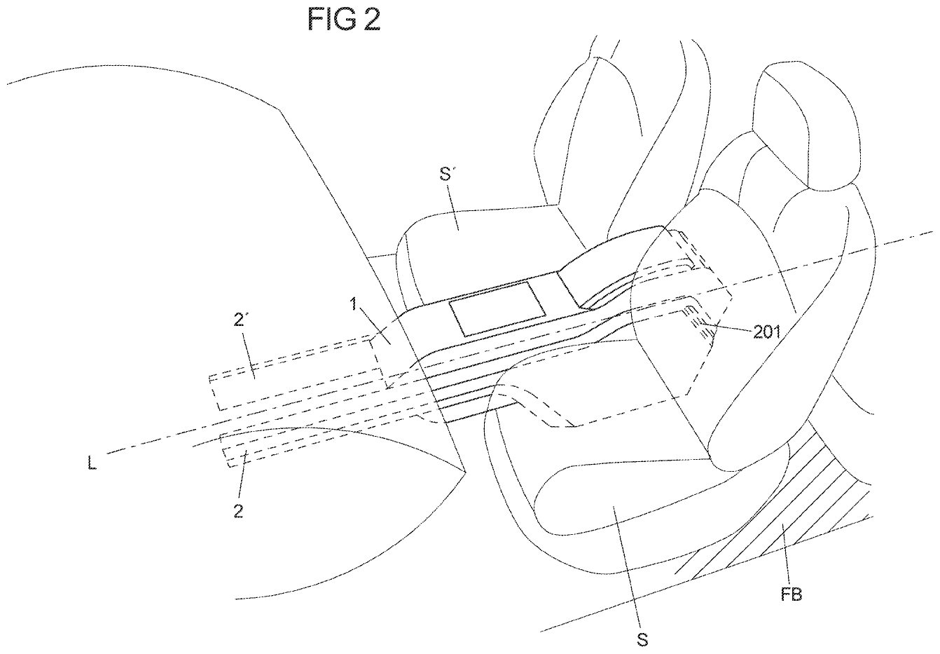

The motor vehicle assembly of FIG. 2 may include two guide arms 2, 2′ which for shifting the center component 1 are inclined along the first direction R1. The guide arms 2, 2′ are extended parallel to each other from the vehicle floor FB to a dashboard A between the driver seat S and the front passenger seat S′. Hence, the guide arms 2, 2′ on the one hand are attached to the vehicle floor FB and on the other hand engage into the dashboard A. The guide arms 2, 2′ are mounted on the vehicle floor FB and on the dashboard A so as to be shiftable along the first direction R1. The guide arms 2, 2′ therefore are shiftable relative to a vehicle body which may include at least the dashboard A and the vehicle floor FB.

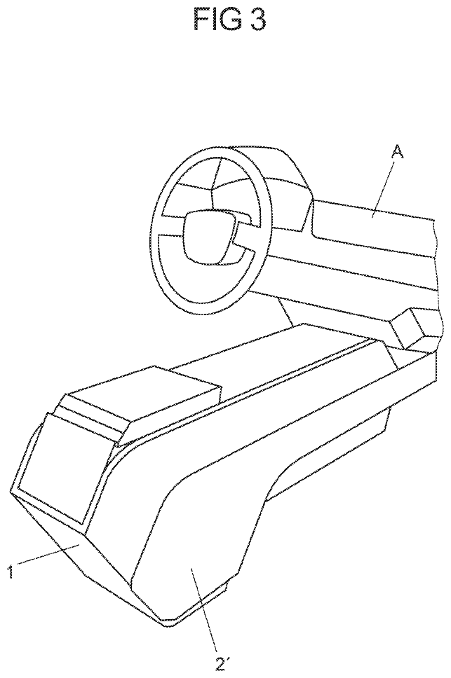

The center component 1 is arranged between the guide arms 2, 2′ so that the center component 1 is shiftable along the first direction R1 together with the guide arms 2, 2′. The center component 1 hence is carried along by the guide arms 2, 2′ during a displacement of the guide arms 2, 2′ along the first direction R1. As a result, the center component 1 is shiftable in the direction of the dashboard A or in the direction of a rear compartment F of the motor vehicle. FIG. 3 shows that during a displacement in the direction of the dashboard A the center component 1 can be retracted into the dashboard A.

In addition, the center component 1 is shiftable relative to the guide arms 2, 2′ along the first and second directions R1, R2. The center component 1 hence is shiftable on the one hand together with the guide arms 2, 2′ and on the other hand relative to the guide arms 2, 2′ along the first direction R1.

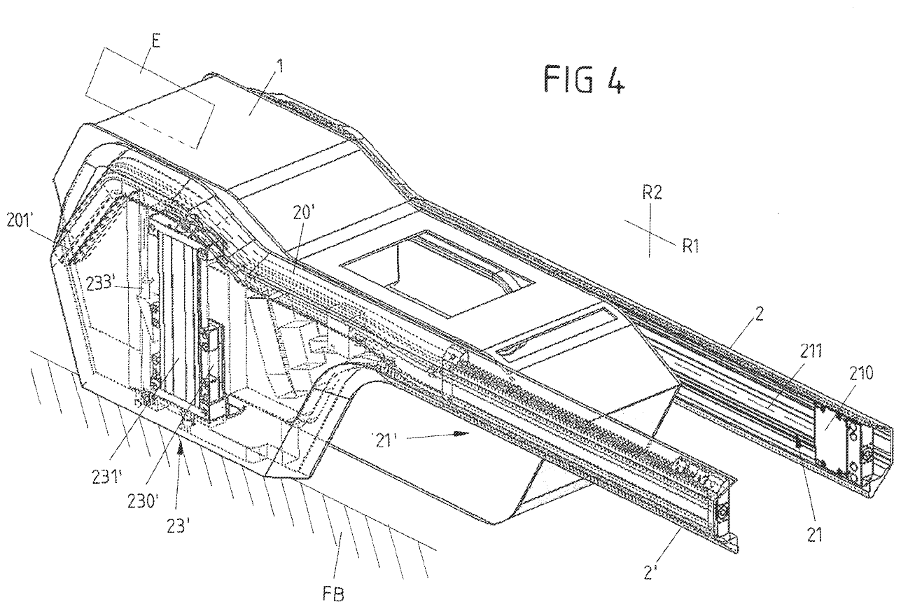

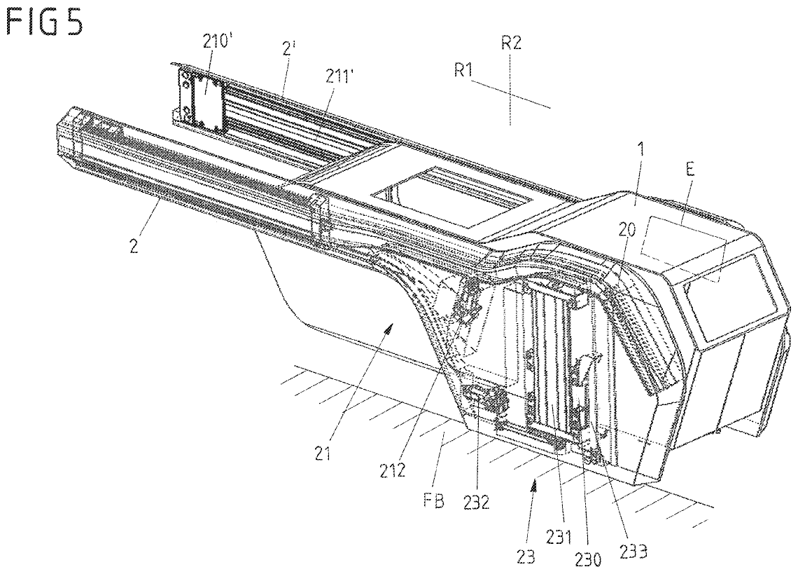

FIG. 4 and FIG. 5 show two guide arms 2, 2′ which to receive the center component 1 between themselves are arranged symmetrically with respect to a mirror plane E, which is extended along the first direction R1 and the second direction R2 and centrally intersects the center component 1.

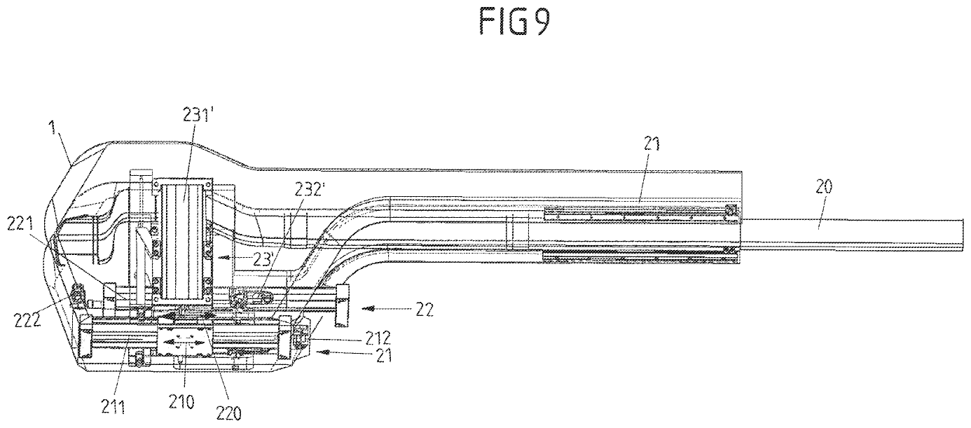

For shifting the guide arms 2, 2′ along the first direction R1, the guide arms 2, 2′ each include a first adjusting mechanism 21, 21′. The first adjusting mechanism 21, 21′ each may include a first guideway 211, 211′. Via the first guideway 211, 211′, the guide arms 2, 2′ each are mounted on the dashboard A. In principle, the guide arms 2, 2′ can likewise be mounted on the vehicle floor FB via the first guideway 211, 211′. In the alternative exemplary embodiment shown in FIG. 9, the guide arms 2, 2′ are mounted on the vehicle floor FB via a common first guideway 211.

It is also conceivable and possible to provide two first guideways on each guide arm 2, 2′, wherein the guide arms 2, 2′ each are mounted on the vehicle floor FB via one of the two first guideways and are mounted on the dashboard A via the other of the two first guideways.

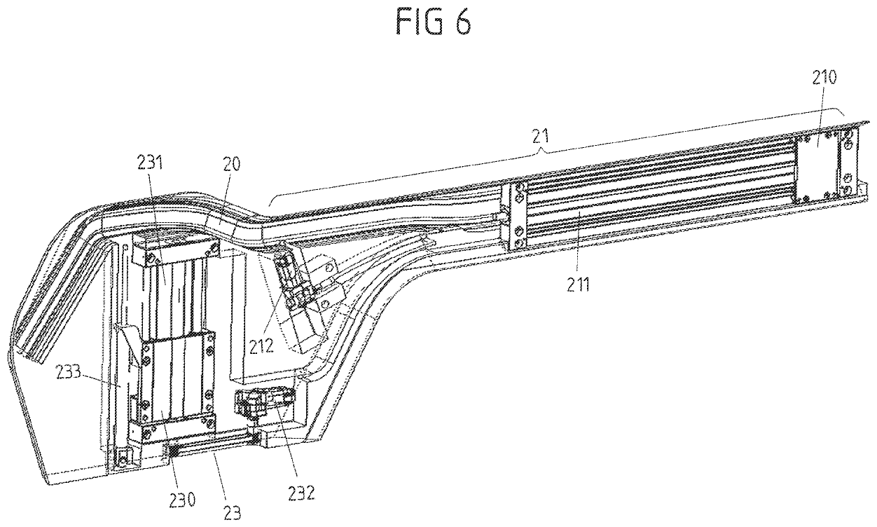

On the first guideway 211 in FIG. 6 a first carriage 210 is arranged. The first carriage 210 is body-mounted. In the illustrated exemplary embodiment, the first carriage 210 is provided and designed for attachment to the dashboard A. It is also conceivable and possible to provide and design the first carriage 210 for being attached to the vehicle floor FB.

The adjustment of the guide arm 2, 2′ relative to the first carriage 210 along the first guideway 211 each is generated via a first spindle drive 212. The first spindle drive 212 hence each serves for introducing a first adjusting force into the guide arms 2, 2′ so that the guide arms 2, 2′ are adjusted relative to the vehicle floor FB along the first direction R1.

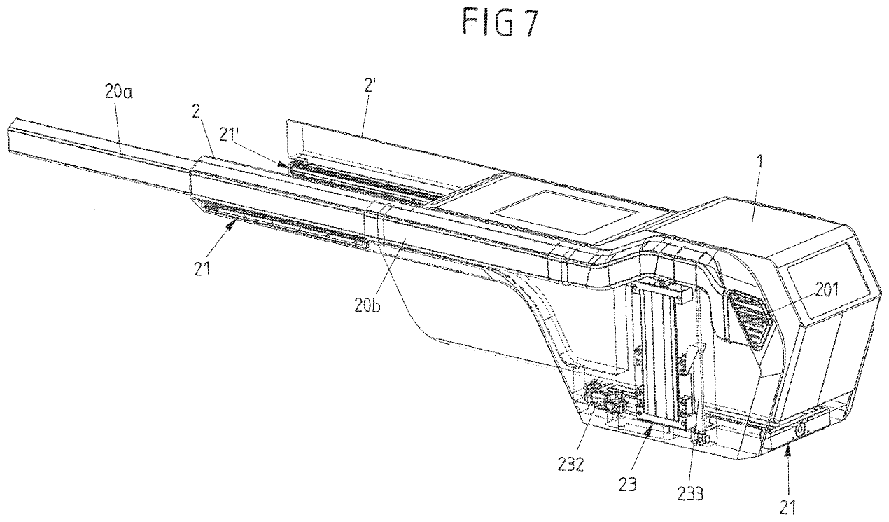

Along the first guideway 211 a ventilation duct 20 proceeding from the dashboard A is extended into the rear compartment of the motor vehicle. Via the ventilation duct 20, air coming from the direction of the dashboard A is transported in the direction of the rear compartment F. Via a ventilation opening 201, the air may be delivered into the rear compartment F. In principle, each of the guide arms 2, 2′ can include a ventilation duct 20, 20′ which each delivers air into the rear compartment F via a ventilation opening 201, 201′, as is also shown in FIG. 4. The ventilation duct 20 can be telescopically increased or reduced in length, as shown in FIG. 7, in order to compensate a displacement of the guide arm 2 relative to the dashboard A. For this purpose, the ventilation duct 20 may include a first duct portion 20a and a second duct portion 20b which has a larger cross-sectional area than the first duct portion 20a. The first duct portion 20a can be nested into the second duct portion 20b in order to reduce a length of the ventilation duct 20 so that the displacement of the guide arm 2 can be compensated.

For shifting the center component 1 along the second direction R2, each of the guide arms 2, 2′ each may include a third adjusting mechanism 23, 23′. The third adjusting mechanism 23, 23′ hence is designed for the height adjustment of the center component 1. The center component 1 is shiftable relative to the guide arms 2, 2′ via the third adjusting mechanisms 23, 23′.

The third adjusting mechanism 23, 23′ each may include a third guideway 231, 231′ which is extended along the second direction R2 and along which the center component 1 is guided. The guidance of the center component 1 on the third guideway 231, 231′ is provided via a third carriage 230, 230′ of the third adjusting mechanism 23, 23′, which is shiftably mounted on the third guideway 231, 231′. The third carriage 230, 230′ hence is shiftable relative to the respective guide arm 2, 2′ along the second direction R2. The two third carriages 230, 230′ are arranged symmetrically with respect to the mirror plane E. The adjustment of the third carriage 230, 230′ along the third guideway 231, 231′ each is effected via a third spindle drive 232, 232′.

Furthermore, the third adjusting mechanism 23, 23′ each may include a support element 233, 233′ on each guide arm 2, 2′ in order to support the weight of the center component 1, so that part of the weight of the center component 1 is supported on the third carriages 230, 230′ and a part is supported on the support elements 233, 233′. The support elements 233, 233′ here are configured as gas pressure springs.

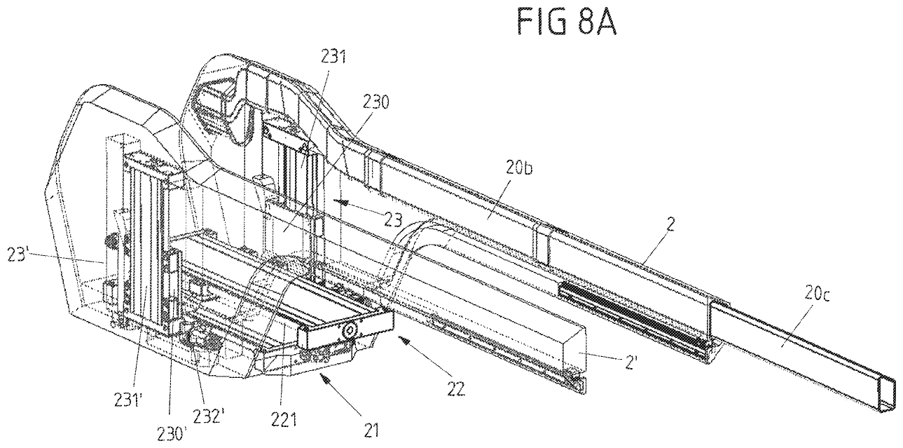

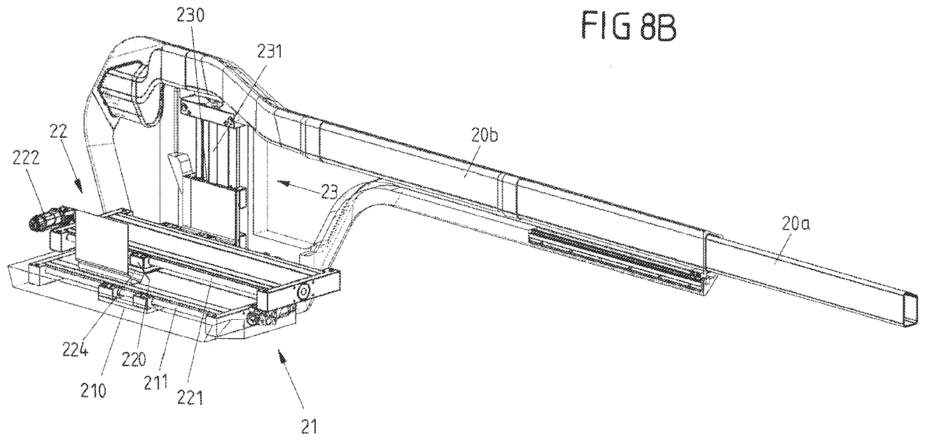

FIG. 8A shows a second adjusting mechanism 22 for shifting the center component 1 relative to the guide arms 2, 2′ along the first direction R1. For shifting along the first direction R1, the center component 1 is shiftable relative to the third carriages 230, 230′ of the third adjusting mechanisms 23, 23′. The third carriages 230, 230′ are connected to each other via a carrier element 224 which is extended between the guide arms 2, 2′ transversely to the first direction R1 and the second direction R2. The carrier element 224 is shiftable along the second direction R2 together with the third carriages 230, 230′. The center component 1 is arranged on the third carriages 230, 230′ via the carrier element 224. For receiving the center component 1, the carrier element 224 is of U-shaped design, wherein the long sides of the U-shaped carrier element 224 are arranged on the guide arms 2, 2′. The second adjusting mechanism 22 provides for a shiftability of the center component 1 relative to the carrier element 224 along the first direction R1 regardless of the position of the center component 1 along the second direction R2.

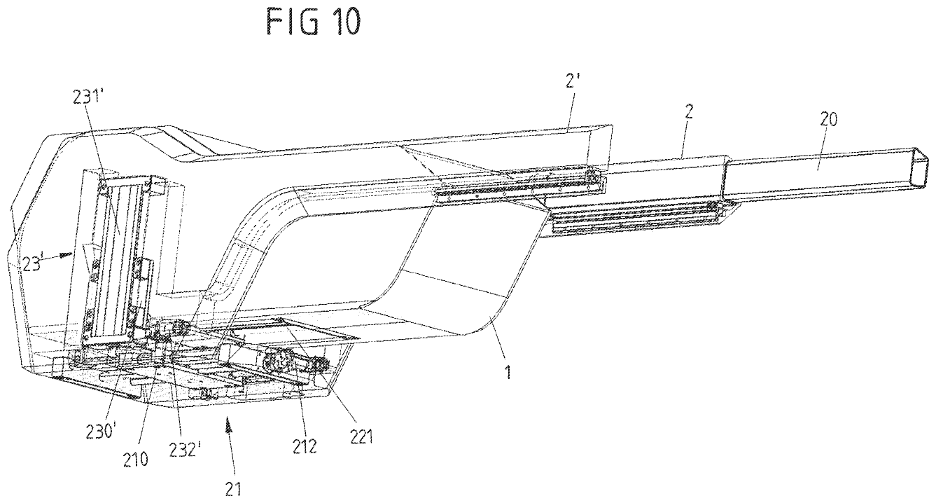

As shown in FIG. 10, the second adjusting mechanism 22 is arranged on the center component 1 on the side of the vehicle floor FB. In an alternative embodiment, the motor vehicle assembly may include two second adjusting mechanisms which each are arranged on the center component 1 on the side of the guide arms 2, 2′ and provide for a displacement of the center component 1 relative to the vehicle floor FB along the first direction R1 and for example, relative to the third carriage 230, 230′.

The second adjusting mechanism 22 may include a second guideway 221 which is extended along the first direction R1 and along which the center component 1 is guided. The guidance of the center component 1 on the second guideway 221 is provided via a second carriage 220 of the second adjusting mechanism 22 which is shiftably mounted on the second guideway 221. The second carriage 220 hence is shiftable relative to the guide arms 2, 2′ along the first direction R1. The adjustment of the second carriage 220 along the second guideway 221 is effected via a second spindle drive 222. The first adjusting mechanism 21, 21′ and the second adjusting mechanism 22 hence can be adjusted separately from each other, simultaneously in opposite directions or simultaneously in a common direction, as can also be taken from the alternative exemplary embodiment of FIG. 9.

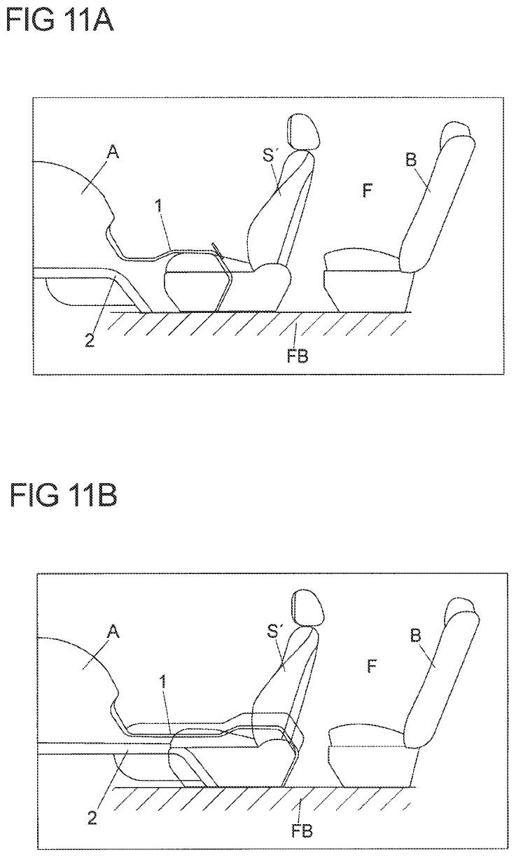

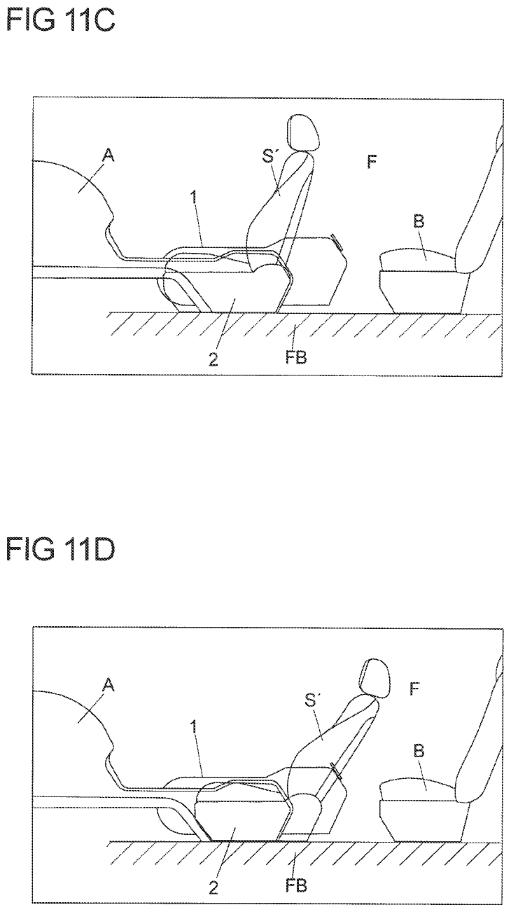

FIG. 11A to FIG. 11D show exemplary arrangements of the motor vehicle assembly relative to a front passenger seat S′ and a rear bench B.

FIG. 11A shows a parking position in which the motor vehicle assembly is arranged along the first direction R1 at least partly below the dashboard A. The guide arms 2, 2′ and the center component 1 are maximally shifted along the first direction R1 below the dashboard A. As a result, the motor vehicle assembly protrudes from the dashboard A only up to a fraction of the length of a front passenger seat S′. Moreover, the center component 1 is maximally shifted along the second direction R2 in the direction of the vehicle floor FB so that less height is claimed under the dashboard A as compared to a further spacing of the center component 1 from the vehicle floor FB.

FIG. 11B shows a normal position in which the motor vehicle assembly is shifted along the first direction R1 up to a back side of the front passenger seat S′ facing the rear compartment F of the motor vehicle. The displacement along the first direction R1 has been achieved with a displacement of the guide arms 2, 2′ relative to the vehicle floor FB. Moreover, the center component 1 is spaced apart further from the vehicle floor FB than in the parking position. The center component 1 hence is shifted relative to the guide arms 2, 2′ along the second direction R2 as compared to the parking position.

FIG. 11C shows an extended position in which the center component 1 is extended relative to the guide arms 2, 2′ along the first direction R1 towards the rear passenger compartment F. The center component 1 here protrudes beyond the guide arms 2, 2′ into the rear compartment F. The center component 1 also protrudes beyond the back side of the front passenger seat S′ so that an occupant of the motor vehicle properly seated on the rear bench B can reach the center component 1 more easily than in the normal position.

FIG. 11D shows a relax position in which the arrangement of the motor vehicle assembly is identical to the extended position. The front passenger seat S′ additionally is adjusted to the rear so that in the extended position the motor vehicle assembly can be used by an occupant properly seated on the front passenger seat S′.

Of course, the explanations set forth in connection with FIGS. 11A to 11D do not only apply with regard to a motor vehicle assembly arranged on a front passenger seat S′, but also with regard to a motor vehicle assembly arranged on a driver seat S or in principle with regard to a motor vehicle assembly arranged between a driver seat S and a front passenger seat S′.

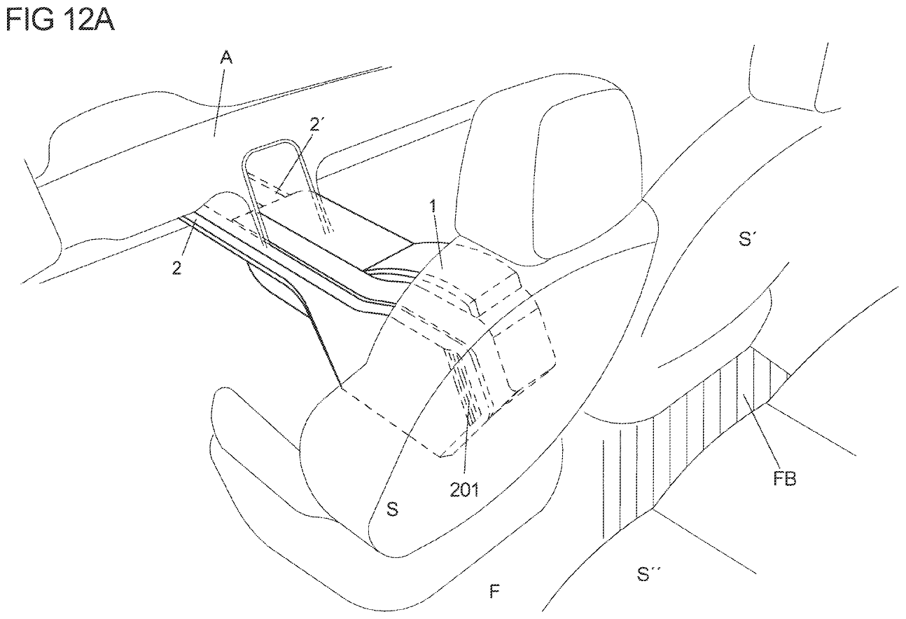

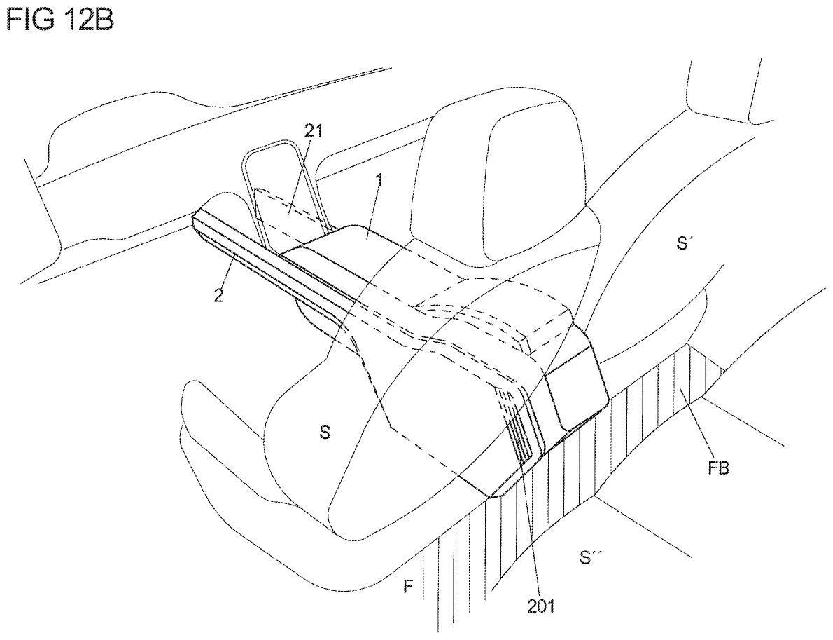

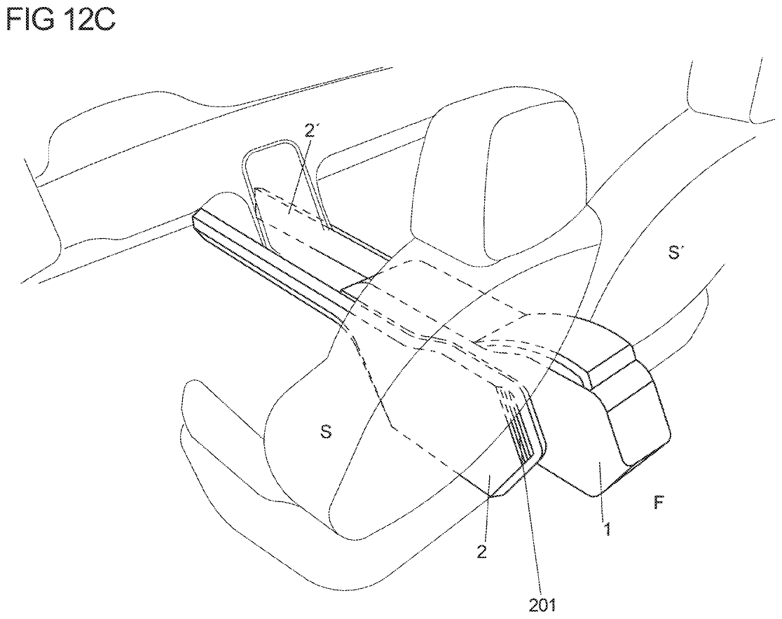

FIGS. 12A to 12C show a sequence of an adjustment of a motor vehicle assembly from the parking position into the extended position.

Proceeding from the parking position shown in FIG. 12A, in which the center component 1 is arranged close to the vehicle floor FB and at least part of the motor vehicle assembly is arranged under the dashboard A, the motor vehicle assembly is shifted from the normal position shown in FIG. 12B, in which the center component 1 is spaced apart further from the vehicle floor FB than in the parking position, into the extended position in which the center component 1 protrudes from the guide arms 2, 2′ in the direction of the rear compartment F.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

Reference Numerals

| | |
|---|---|
| 1 | center component |
| 2, 2′ | guide arm |
| 20 | ventilation duct |
| 20a | first duct portion |
| 20b | second duct portion |
| 201, 201′ | ventilation opening |
| 21, 21′ | first adjusting mechanism |
| 22 | second adjusting mechanism |
| 23, 23′ | third adjusting mechanism |
| 210, 210′ | first carriage |
| 220 | second carriage |
| 230, 230′ | third carriage |
| 211, 211′ | first guideway |
| 221 | second guideway |
| 231, 231′ | third guideway |
| 212 | first spindle drive |
| 222 | second spindle drive |
| 232, 232′ | third spindle drive |
| 224 | carrier element |
| 233, 233′ | support element |
| A | dashboard |
| B | rear bench |
| E | mirror plane |
| F | rear passenger compartment |
| FB | vehicle floor |
| R1 | first direction |
| R2 | second direction |
| S, S′ | vehicle seat |

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A motor vehicle assembly comprising:
a center component configured to be arranged between two vehicle seats disposed on a vehicle floor and shiftable along a first direction parallel to the vehicle floor and a second direction perpendicular to the vehicle floor.

2. The motor vehicle assembly of claim 1, further comprising:
at least one guide arm shiftably arranged on a vehicle body along the first direction wherein the center component is arranged on the at least one guide arm so that the center component and the at least one guide arm are shiftable along the first direction.

3. The motor vehicle assembly of claim 2, wherein the at least one guide arm is shiftably arranged on a dashboard of the motor vehicle along the first direction.

4. The motor vehicle assembly of claim 2, wherein the center component is releasably arranged on the at least one guide arm so that the center component is exchangeable with another center component.

5. The motor vehicle assembly of claim 2, further comprising:
at least one ventilation duct configured to transport air along the first direction and extending along the at least one guide arm.

6. The motor vehicle assembly of claim 2, wherein the at least one guide arm includes a first guide arm and a second guide arm, each arranged symmetrically with respect to a mirror plane extending along the first direction and centrally intersecting the center component, wherein the center component is arranged between the first and second guide arms.

7. The motor vehicle assembly of claim 2, further comprising:
a first adjusting mechanism disposed on the at least one guide arm configured to shift the at least one guide arm relative to a vehicle body along the first direction.

8. The motor vehicle assembly of claim 7, wherein the center component is arranged on the at least one guide arm so that the center component is shiftable along the first direction and/or along a second direction relative to the at least one guide arm.

9. The motor vehicle assembly of claim 8, further comprising:
a second adjusting mechanism disposed on the at least one guide arm, wherein the second adjusting mechanism is arranged so that the center component is shiftable along the first direction relative to the at least one guide arm.

10. The motor vehicle assembly of claim 9, further comprising:
a third adjusting mechanism disposed on the at least one guide arm, wherein the center component is shiftable along the second direction relative to the at least one guide arm.

11. The motor vehicle assembly of claim 10, wherein the first adjusting mechanism, the second adjusting mechanism and/or the third adjusting mechanism include a carriage and a guideway, and the carriage is shiftable relative to the guideway to shift the center component.

12. The motor vehicle assembly of claim 10, further comprising:
a support element arranged on the at least one guide arm and configured to support the third adjusting mechanism and weight of the center component.

13. A console for use in a motor vehicle, the console comprising:
a guide arm configured to be coupled to a dashboard;
a center portion configured to selectively move with the guide arm in a first direction, parallel to a floor of the motor vehicle, and a second direction, perpendicular to the vehicle floor; and
a ventilation duct extending from the dashboard along the guide arm and terminating at a ventilation opening configured to transmit air towards a rear seat.

14. The console of claim 13, further comprising:
a guideway configured to be fixed to the dashboard, wherein the guide arm is configured to is coupled to the guideway and configured to selectively move along the guideway.

15. The console of claim 14, further comprising:
a first carriage disposed on the guideway; and
a first spindle drive operatively coupled to the carriage and configured to move the guide arm in the first direction.

16. The console of claim 15, further comprising:
a second guideway extending in the second direction;
a second carriage coupled to and configured to move along the second guideway; and
a second spindle drive operatively coupled to the second carriage and configured to move the second carriage in the second direction.

17. The console of claim 16, further comprising:
a carrier element connected to the second carriage and the center portion, wherein the carrier element is U-shaped.

18. The console of claim 13, wherein the center portion is configured to move between a normal position, in which the center portion is disposed adjacent to a rear portion of a front seat of the motor vehicle, and a parking position, in which at least a portion of the center portion is disposed below the dashboard.

19. A console for use in a motor vehicle, the console comprising:
a first guide arm;
a second guide arm spaced apart from the first guide arm;
a center portion fixed to the first guide arm and the second guide arm;
a first adjusting mechanism configured to move the first guide arm in a first direction parallel to a floor of the motor vehicle;
a second adjusting mechanism configured to move the second guide arm in the first direction; and
a ventilation duct extending from a dashboard of the motor vehicle along the first guide arm and terminating at a ventilation opening configured to transmit air towards a rear seat.

20. The console of claim 19, wherein the ventilation duct includes a first portion and a second portion, and a portion of the second portion is nested within the first portion.
